(19) United States
(12) Patent Application Publication
(10) Pub. No.: US 2023/0281535 A1
(43) Pub. Date: Sep. 7, 2023

(54) METHODS AND INTERNET OF THINGS SYSTEMS FOR GAS RESOURCE DISPATCHING BASED ON SMART GAS CALL CENTERS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Bin LIU, Chengdu (CN)

(73) Assignee: CHENGDU QINCHUAN IOT TECHNOLOGY CO., LTD., Chengdu (CN)

(21) Appl. No.: 18/314,806

(22) Filed: May 9, 2023

(30) Foreign Application Priority Data
Mar. 22, 2023 (CN) 202310281990.X

(51) Int. Cl. G06Q 10/0631; G06Q 10/0637; G06Q 50/06

(52) U.S. Cl. CPC G06Q 10/06315; G06Q 10/06375; G06Q 50/06

(57) ABSTRACT

The embodiment of the present disclosure provides methods and Internet of Things (IoT) systems for gas resource dispatching based on a smart gas call center. The method is executed by the IoT system for gas resource dispatching based on a smart gas call center. The method includes: obtaining gas use data of different types of gas users and determining a gas use feature; obtaining gas demand data; predicting, based on the gas use feature, the gas demand data, and gas maintenance data of the smart gas call center, whether a gas supply of at least one of a plurality of second times meets a gas demand; in response to a prediction that the gas supply of the at least one of the plurality of the second times is incapable of meeting the gas demand, adjusting a gas dispatching plan.

### CROSS-REFERENCE TO RELATED APPLICATION

This application claims priority of Chinese Patent Application No. 202310281990.X, filled on Mar. 22, 2023, the contents of which are entirely incorporated herein by reference.

### TECHNICAL FIELD

The present disclosure relates to the field of gas resource dispatching, and in particular, to methods and Internet of Things systems for gas resource dispatching based on a smart gas call center.

### BACKGROUND

With the popularization of gas, a gas transmission and distribution network has covered all parts of a city. In an actual operation of the gas transmission and distribution pipeline network, there may be problems such as an unbalanced gas supply and demand, a gas emergency, etc., which affect normal gas supply. Therefore, it is desirable to provide methods and Internet of Things systems for gas resource dispatching based on a smart gas call center to provide a reasonable gas dispatching plan, thereby balancing the demand for gas supply and ensuring the normal gas supply.

### SUMMARY

One or more embodiments of the present disclosure provide a method for gas resource dispatching based on a smart gas call center. The method includes: obtaining gas use data of different types of gas users and determining a gas use feature, the gas use feature at least including the gas use data of the different types of gas users at a plurality of first times; obtaining gas demand data, the gas demand data including a demand time and a demand volume; predicting, based on the gas use feature, the gas demand data, and gas maintenance data of the smart gas call center, and in response to a prediction that the gas supply of the at least one of the plurality of the second times is incapable of meeting the gas demand, adjusting a gas dispatching plan.

One of the embodiments of the present disclosure provides an Internet of Things (IoT) system for gas resource dispatching based on a smart gas call center. The IoT system includes a smart gas user platform, a smart gas service platform, a smart gas management platform, a smart gas sensor network platform, and a smart gas object platform that interact sequentially, and the smart gas management platform at least includes a smart operation management sub-platform and a smart gas data center; the smart gas data center is configured to obtain gas use data and gas demand data of different types of gas users and send the gas use data and the gas demand data to the smart operation management sub-platform for processing, the gas demand data including a demand time and a demand volume; and the smart operation management sub-platform is configured to: determine a gas use feature based on the gas use data, the gas use feature at least including the gas use data of the different types of gas users at a plurality of first times; predict, based on the gas use feature, the gas demand data, and gas maintenance data of the smart gas call center, whether gas supplies at a plurality of second times meets gas demands; in response to a prediction that the gas supply of at least one of the plurality of the second times is incapable of meeting the gas demand, adjust a gas dispatching plan; and send the adjusted gas dispatching plan to the smart gas data center and send the adjusted gas dispatching plan to the smart gas user platform via the smart gas service platform.

One or more embodiments of the present disclosure provide a non-transitory computer readable storage medium storing computer instructions. When the computer instructions are executed by a processor, the method for gas resource dispatching based on a smart gas call center is implemented.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which the same reference numbers represent the same structures, wherein:

FIG. 1 is a schematic diagram illustrating a platform structure of an Internet of Things (IoT) system for gas resource dispatching based on a smart gas call center according to some embodiments of the present disclosure;

FIG. 2 is a flowchart illustrating an exemplary process of a method for gas resource dispatching based on a smart gas call center according to some embodiments of the present disclosure;

FIG. 3 is a schematic diagram illustrating an exemplary prediction model according to some embodiments of the present disclosure;

FIG. 4 is a flowchart illustrating an exemplary process for adjusting a gas dispatching plan according to some embodiments of the present disclosure; and

FIG. 5 is an exemplary schematic diagram illustrating adjusting a gas dispatching plan according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

With the popularization of gas, a gas transmission and distribution network has covered all parts of a city. In an actual operation of the gas transmission and distribution pipeline network, there may be problems such as an unbalanced gas supply and demand, a gas emergency, etc., which will affect normal gas supply.

In view of this, in some embodiments of the present disclosure, methods and Internet of Things (IoT) systems for gas resource dispatching based on a smart gas call center is provided, whether a gas supply of a gas pipeline in a future time meets a gas demand is predicted, and according to a demand and an important degree of a user, a reasonable gas dispatching plan may be provided, which can reduce the impact of insufficient gas supply on the gas user, improve a user satisfaction, balance the demand for gas supply, and ensure a normal gas supply.

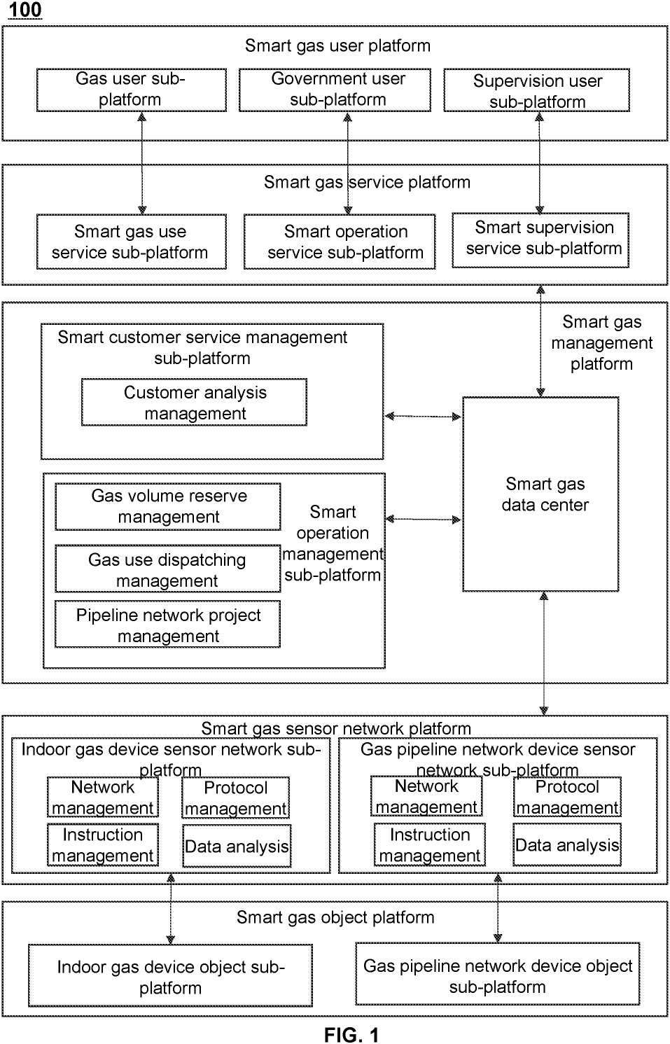

FIG. 1 is a schematic diagram illustrating a platform structure of an IoT system for gas resource dispatching based on a smart gas call center according to some embodiments of the present disclosure.

In some embodiments, the IoT system 100 for gas resource dispatching based on a smart gas call center may include a smart gas user platform, a smart gas service platform, a smart gas management platform, a smart gas sensor network platform, and a smart gas object platform that interact sequentially.

The smart gas user platform may be a platform that interacts with a user. The user may be a gas user, a supervision user, etc. In some embodiments, the smart gas user platform may be configured as a terminal device, for example, the terminal device may include a mobile device, a tablet computer, or the like, or any combination thereof. In some embodiments, the smart gas user platform may be configured to feedback information to the user. For example, the smart gas user platform may be configured to feedback gas dispatching management information to the user.

In some embodiments, the smart gas user platform is provided with a gas user sub-platform, a government user sub-platform, and a supervision user sub-platform. The gas user sub-platform is oriented to the gas user, which provides information on data related to gas use and a solution to a gas problem. The gas user refers to a user who uses the gas. In some embodiments, the gas user sub-platform may correspond to and interact with a smart gas use service sub-platform to obtain a safe gas use service. The government user sub-platform is oriented to the government user, which provides data related to gas operation. The government user refers to a user of a department related to government gas operation. In some embodiments, the government user sub-platform may correspond to and interact with a smart operation service sub-platform. For example, the government user sub-platform may issue a query instruction about gas dispatching management information to the smart operation service sub-platform. As another example, the government user sub-platform may obtain the gas dispatching management information uploaded by the smart operation service sub-platform (such as gas storage, gas dispatching, etc.). The supervision user sub-platform is oriented to the supervision user, which supervises the operation of the entire IoT system. The supervision user refers to a user of a safety department. In some embodiments, the supervision user sub-platform may correspond to and interact with a smart supervision service sub-platform to obtain a service required by safety supervision. In some embodiments, the smart gas user platform may perform a bidirectional interaction with the smart gas service platform, send feedback information of the gas user to the smart gas use service sub-platform, and receive customer service feedback information uploaded by the smart gas use service sub-platform. The smart gas user platform may further issue the query instruction on the gas dispatching management information to the smart operation service sub-platform and receive the gas dispatching management information uploaded by the smart operation service sub-platform.

The smart gas service platform may be a platform for receiving and transmitting data and/or information. In some embodiments, the smart gas service platform may interact downwardly with the smart gas management platform, issue the query instruction on the gas dispatching management information to the smart gas data center and receive the gas dispatching management information uploaded by the smart gas data center. In some embodiments, the smart gas service platform may interact upwardly with the smart gas user platform. In some embodiments, the smart gas service platform may be provided with the smart gas use service sub-platform, the smart operation service platform, and the smart supervision service sub-platform. The smart gas use service sub-platform may interact with the gas user sub-platform to provide the gas user with gas use information. The smart operation service sub-platform may interact with the government user sub-platform, receive the query instruction on the gas dispatching management information issued by the government user sub-platform and upload the gas dispatching management information to the government user sub-platform. The smart supervision service sub-platform may interact with the supervision user sub-platform to provide supervision information for the supervision user.

The smart gas management platform refers to a platform that overall plans coordinates the connection and collaboration between various functional platforms, gathers all information of the IoT, and provides perception management and control management functions for the IoT operation system. In some embodiments, the smart gas management platform may downwardly interact with the smart gas sensor network platform. For example, the smart gas management platform may issue the instruction to obtain data related to a gas device to the smart gas sensor network platform and receive the data (e.g., gas use data and gas demand data, etc.) related to the gas device uploaded by the smart gas sensor network platform. The smart gas management platform may further interact upwardly with the smart gas service platform, receive the query instruction on the gas dispatching management information issued by the smart gas service platform, and upload the gas dispatching management information to the smart gas service platform.

In some embodiments, the smart gas management platform is provided with a smart customer service management sub-platform, a smart operation management sub-platform, and a smart gas data center. Each management sub-platform may interact bidirectionally with the smart gas data center, and the smart gas data center summarizes and stores all the operation data of the IoT system 100 for gas resource dispatching based on a smart gas call center. In some embodiments, the smart gas management platform may perform a data interaction with the smart gas sensor network platform and the smart gas service platform through the smart gas data center. For example, the smart gas data center may receive the query instruction on the gas dispatching management information issued by the smart operation service sub-platform, receive the customer feedback information issued by the smart gas use service sub-platform, and send the customer feedback information to the smart customer service management sub-platform for processing, etc. For example, the smart gas data center may receive the data related to the gas device uploaded by the smart gas sensor network platform and send the data related to the gas device to the smart operation management sub-platform for processing. In some embodiments, the smart customer service management sub-platform may be configured to achieve customer analysis and management, etc. and may check the customer feedback information and perform a corresponding reply processing. In some embodiments, the smart operation management sub-platform may be configured to achieve gas volume reserve management, gas use dispatching management, and pipeline network project management, etc. and may check work order information, personnel configuration, and a progress of the pipeline network project to realize the pipeline network project management, etc.

The smart gas sensor network platform may be a functional platform for managing sensor communication. In some embodiments, the smart gas sensor network platform may be configured as a communication network and a gateway to realize functions such as network management, protocol management, instruction management, and data analysis. In some embodiments, the smart gas sensor network platform may perform the data interaction with the smart gas management platform and the smart gas object platform to realize functions of perceptual information sensor communication and control information sensor communication. For example, the smart gas sensor network platform may issue the instruction to obtain the data related to the gas device to the smart gas object platform and receive the data related to the gas device uploaded by the smart gas object platform. As another example, the smart gas sensor network platform may receive the instruction to obtain the data related to the gas device issued by the smart gas data center and upload the data related to the gas device to the smart gas data center.

In some embodiments, the smart gas sensor network platform may include an gas indoor device sensor network sub-platform and a gas pipeline network device sensor network sub-platform. The gas indoor device sensor network sub-platform may correspond to a gas indoor device object sub-platform and is used to obtain relevant data of an indoor device (e.g., a metering device, etc.). The gas pipeline network device sensor network sub-platform may correspond to a gas pipeline network device object sub-platform and is configured to obtain relevant data (all belong to gas device related data) of a pipeline network device (e.g., a gas door station compressor, a pressure regulating device, a gas flow meter, a valve control device, a thermometer, a barometer, etc.).

The smart gas object platform may be a functional platform for perceptual information generation and control information execution. In some embodiments, the smart gas object platform may be configured to include at least one gas device and at least one other device. The gas device may include the indoor device and the pipeline network device. The other device may include a monitoring device, a temperature sensor, a pressure sensor, etc. In some embodiments, the smart gas object platform may interact upwardly with the smart gas sensor network platform, receive the instruction to obtain the data related to the gas device issued by the smart gas sensor network platform, and upload the data related to the gas device to the smart gas sensor network platform.

In some embodiments, the smart gas object platform may be provided with the gas indoor device object sub-platform and the gas pipeline network device object sub-platform. The gas indoor device object sub-platform corresponds to the gas indoor device sensor network sub-platform and is configured to upload the data related to the indoor device to the smart gas data center through the gas indoor device sensor network sub-platform. The gas pipeline network device object sub-platform corresponds to the gas pipeline network device sensor network sub-platform and is configured to upload the data related to the pipeline network device to the smart gas data center through the gas pipeline network device sensor network sub-platform.

It should be noted that the above descriptions of the IoT system and components thereof is merely for convenient of illustration, and not intended to limit the present disclosure to the scope of the embodiments. It may be understood that for those skilled in the art, after understanding the principle of the system, it is possible to arbitrarily combine the various parts, or form a subsystem to connect with other parts without departing from the principle. For example, the smart gas service platform and the smart gas management platform may be integrated into one component. As another example, each component may share a storage device, and each component may also have respective storage device. Such deformations are all within the scope of the protection of the present disclosure.

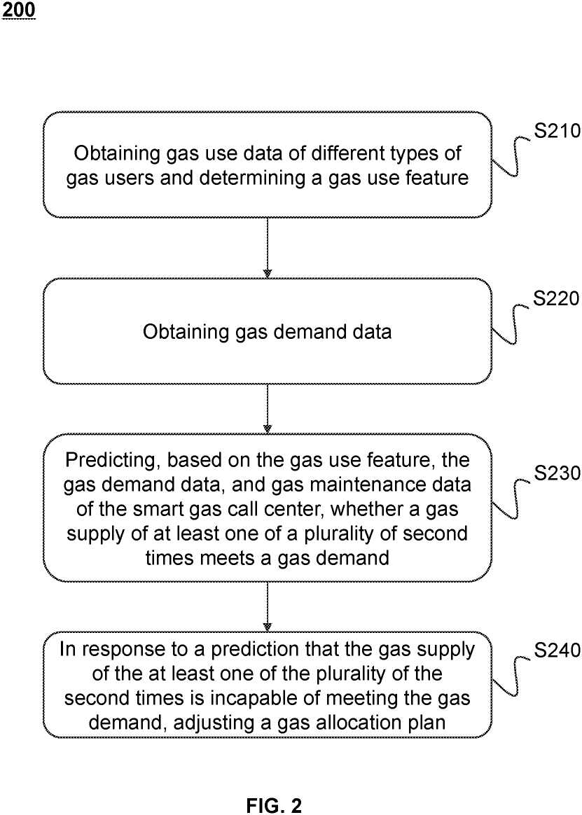

FIG. 2 is a flowchart illustrating an exemplary process of a method for gas resource dispatching based on a smart gas call center according to some embodiments of the present disclosure. In some embodiments, the process 200 may be executed by a smart gas management platform. As shown in FIG. 2, the process 200 includes the following operations.

In 210, obtaining gas use data of different types of gas users and determining a gas use feature.

The different types of gas users may include a residential user, a commercial user (e.g., a gas filling station, a natural gas power plant, etc.), and an industrial user (e.g., a factory that needs to use gas). In some embodiments, the type of the gas user may be determined based on a supply address of a corresponding gas pipeline. For example, the type of the gas user corresponding to the gas pipeline whose supply address is a residential area may be determined as the residential user. It should be noted that different types of gas users may correspond to different types of gas pipelines. For example, the residential users correspond to the residential pipelines, the commercial users correspond to commercial pipelines, and the industrial users correspond to industrial pipelines. A gas pipeline may be configured to supply gas to one or more gas users of the same type. For example, a residential pipeline A may be configured to supply gas to 200 residential users.

The gas use data refers to data related to gas use. One type of gas user may correspond to a set of gas use data.

In some embodiments, the gas use data may include a gas use volume, a gas use time, etc. of a certain type of gas user. For example, the gas use data of a certain type of gas user may be (x, y), where x indicates the gas use volume of this type of gas user, and y indicates the gas use time of this type of gas user.

In some embodiments, the gas use data may further include a gas use volume, a gas use time, etc. of each of a plurality of gas pipelines corresponding to a certain type of gas user. For example, the gas use data of a certain type of gas user may be ([x₁, y₁], [x₂, y₂], ...), where x₁ indicates the gas use volume of gas pipeline 1, and y₁ indicates the gas use time of the gas pipeline 1; x2 indicates the gas use volume of gas pipeline 2, y₂ indicates the gas use time of the gas pipeline 2, etc.

In some embodiments, the gas use data may be obtained through the smart gas object platform. For example, the gas use data can be obtained through a device such as a gas meter.

The gas use feature refers to a feature related to the gas use data of each gas pipeline. For example, the gas use feature may be a feature related to the gas use volume of a certain gas pipeline.

In some embodiments, the gas use feature at least includes the gas use data of the different types of gas users at a plurality of first times.

The first time refers to a time point or a time period when the gas user used the gas in history. The first time may be determined in various ways. For example, a length of time may be preset, and the time in a day is divided into a plurality of time periods according to the length of time, so as to obtain the plurality of first times. As another example, a time point may be taken at an interval as the first time. In some embodiments, the first time may be adjusted according to a factor such as a peak period, a valley period, and a season of the gas use. For example, the length of the first time during a peak period of the gas use may be relatively long or the first time may be relatively intensive. As another example, when the season is winter, the length of the first time may be relatively long or the first time may be relatively intensive.

The gas use feature may be represented by a vector. The gas use feature includes a sub-use feature corresponding to each gas pipeline. For example, the gas use feature may be expressed as ([a₁, b₁], [a₂, b₂], ...), where [a₁, b₁] indicates the sub-use feature of a gas pipeline 1, and [a₂, b₂] indicates the sub-use feature of a gas pipeline 2, etc.; a₁, a₂, etc. indicate the plurality of first times; b₁ indicates the gas use volume corresponding to the gas pipeline 1 at the first time a₁, b₂ indicates the gas use volume corresponding to the gas pipeline 2 at the first time a₂, etc.

In some embodiments, the gas use feature may be determined by integrating and analyzing the gas use data of one or more gas users corresponding to a certain gas pipeline. For example, the gas use data of the one or more gas users corresponding to a certain gas pipeline may be integrated, a feature extraction is performed on the integrated gas use data, and the gas use feature is determined. For example, the gas use data of a residential user A includes the gas use time of 07:00-08:00, and the gas use volume of 0.2 m³; the gas use data of a residential user B includes the gas use time of 07:00-08:00, and the gas consumption of 0.1 m³, and the gas use data of a residential user C includes the gas use time of 11:00-12:00, and the gas consumption of 0.2 m³. The residential user A and the resident user B correspond to the gas pipeline 1, and the resident user C corresponds to the gas pipeline 2. Through the integration and the feature extraction of the gas use data of each residential user corresponding to each gas pipeline, the gas use feature may be determined as ([07:00-08:00, 0.3], [11:00-12:00, 0.2]), where [07:00-08:00, 0.3] represents the gas use feature of the gas pipeline 1, and [11:00-12:00, 0.2] represents the gas use feature of the gas pipeline 2.

In 220, obtaining gas demand data.

The gas demand data refers to data related to the gas use. In some embodiments, the gas demand data may include a demand time, a demand volume, etc. Different gas pipelines may correspond to different gas demand data.

The demand time refers to a time when the gas user needs to use the gas. The demand time may be a future time after a current time. In some embodiments, different types of gas users may have different demand times.

The demand volume (also called the gas demand volume) refers to a volume of gas that the gas user needs to use. In some embodiments, different types of gas users may have different demand volumes.

The gas demand data may be obtained in various ways. For example, the gas demand data may be obtained from the data input by one or more gas users corresponding to a certain gas pipeline in the gas user sub-platform.

In 230, predicting, based on the gas use feature, the gas demand data, and gas maintenance data of the smart gas call center, whether a gas supply of at least one of a plurality of second times meets a gas demand.

A smart gas call center refers to a service center that provides a gas-related service to the gas user. For example, the gas user may obtain a relevant service such as connection, consultation, and maintenance of the gas through the smart gas call center.

The gas maintenance data of the smart gas call center refers to data related to maintenance and processing of a gas-related device (e.g., a gas pipeline, a gas device, etc.). When a certain gas pipeline is under maintenance, the gas pipeline may stop supplying gas.

In some embodiments, the gas maintenance data of the smart gas call center may include an estimated maintenance start time, an estimated gas supply restoration time, a current maintenance work order, and an estimated maintenance work order.

The estimated maintenance start time refers to a time when the maintenance on the gas facilities is estimated to start.

The estimated maintenance start time may be determined in various ways. For example, the estimated maintenance start time may be determined based on an estimated time of arriving at an abnormal or damaged gas-related device and the current time.

The estimated gas supply restoration time refers to a time when the maintenance of the gas device is completed and the gas supply may be restored. The estimated gas supply restoration time may be determined in various ways. For example, the estimated gas supply restoration time may be determined according to a damage degree of the gas-related device and the estimated maintenance start time. For example, a maintenance duration may be determined according to comparison between the damage degree and a first preset table. The estimated gas supply restoration time may be determined based on the maintenance duration and the estimated maintenance start time. The first preset table includes various reference damage degrees and reference maintenance durations corresponding to the reference damage degrees. When compared, an actual damage degree is matched with the reference damage degree, and the reference maintenance duration corresponding to the reference damage degree that meets a preset condition (e.g., the same or the closest, etc.) is used as a final maintenance duration.

The current maintenance work order refers to a maintenance work order currently under processing. The current maintenance work order may include a maintenance time and a maintenance location of the gas-related device (e.g., a certain gas pipeline, etc.). In some embodiments, the current maintenance work order may further include a gas storage volume of a backup gas pipeline or a backup gas storage device of the gas-related device. When a certain gas pipeline is maintained, the gas supply may be carried out through the backup gas pipeline or the backup gas storage device. The current maintenance work order may be obtained from a work record of the smart gas call center.

The estimated maintenance work order refers to a maintenance work order that is estimated to be processed. For example, the estimated maintenance work order may be an estimated maintenance time, an estimated maintenance location, etc. for the maintenance of the relevant gas device that may be damaged. Similar to the current maintenance work order, the estimated maintenance work order may include the gas storage volume of the backup gas pipeline or the backup gas storage device of the gas-related device. The estimated maintenance work order may be determined in various ways. For example, the estimated maintenance work order may be determined based on the gas-related device whose regular maintenance time is approaching in a regular maintenance work table (including the gas-related device requiring the regular maintenance and the regular maintenance time).

The second time refers to a time point or a time period when the gas is used in the future. The second time may be determined in various ways. For example, a time period in the future may be manually selected as the second time. As another example, a time point may be manually selected at an interval as the second time. Similar to the first time, the second time may be adjusted according to the factor such as the peak period, the valley period, and the season of the gas use. For more descriptions, please refer to the relevant description above, which will not be repeated here.

The gas supply refers to relevant data of the gas supply for the gas users. For example, the gas supply may include a gas supply time, a gas supply volume, etc. In some embodiments, the gas supply may be determined based on an initially determined gas dispatching plan. For more descriptions about the gas dispatching plan, please refer to the operation 240 and the related descriptions.

The gas demand refers to gas demand data of the gas user. For relevant descriptions on the gas demand data, please refer to the previous relevant sections.

In some embodiments, the smart operation management sub-platform may predict, based on the gas use feature and the gas demand data, an expected gas use feature of the at least one of the plurality of second times and predict, based on the expected gas use feature of the at least one of the plurality of second times and the gas maintenance data, whether the gas supply of the at least one of the plurality of second times meets the gas demand.

The expected gas use feature refers to a feature related to the gas use data of a certain gas pipeline at the second time. For example, the expected gas use feature may be a feature related to the gas use volume of a certain gas pipeline at the second time.

The expected gas use feature may be represented by a vector. The expected gas use feature includes a sub-expected use feature corresponding to each gas pipeline. For example, the expected gas use feature may be indicated as ([c₁, d₁], [c₂, d₂], ...), where [c₁, d₁] indicates the sub-expected use feature of the gas pipeline 1, and [c₂, d₂] indicates the sub-expected use feature of the gas pipeline 2, etc.; c₁, c₂, etc. indicate the plurality of second times; d₁ indicates the gas use volume corresponding to the gas pipeline 1 at the second time c₁, d₂ indicates the gas use volume corresponding to the gas pipeline 2 at the second time c₂, etc.

The expected gas use feature may be determined in various ways. For example, under same or similar gas demand data of a certain gas pipeline, a historical gas use feature of the gas pipeline at a historical first time when the gas pipeline is in a same time period as the second time may be determined as the expected gas use feature of the gas pipeline at the second time. For example, under the same or similar gas demand data of a gas pipeline A, if the historical gas use feature of the gas pipeline A from 07:00-08:00 yesterday morning is ([07:00-08:00], 10), the expected gas use feature of the gas pipeline A from 07:00-08:00 tomorrow morning may be determined as ([07:00-08:00], 10).

Whether the gas supply at the second time meets the gas demand may be determined in various ways. In some embodiments, for a certain gas pipeline, the gas demand volume at the second time may be determined based on the expected gas use feature, and the gas supply volume at the second time may be determined based on the gas maintenance data. By determining the gas demand volume and the gas supply volume, whether the gas supply at the second time meets the gas demand may be determined. For example, when the gas demand volume is greater than the gas supply, it may be determined that the gas supply at the second time does not meet the gas demand.

In some embodiments, the gas demand volume of a certain gas pipeline at the second time may be determined based on the respective gas demand volume of one or more corresponding gas users at the second time. For example, the gas demand volume of a certain gas pipeline at the second time may be determined by adding the respective gas demand volume.

In some embodiments, the gas supply volume at the second time may be determined based on the gas maintenance data. For example, when the gas maintenance data does not include the estimated maintenance work order at the second time, the gas supply volume in an initial gas dispatching plan may be determined as the gas supply volume at the second time. When the gas maintenance data includes the estimated maintenance work order at the second time, the gas storage volume of the backup gas pipeline or the backup gas device may be determined as the gas supply volume at the second time.

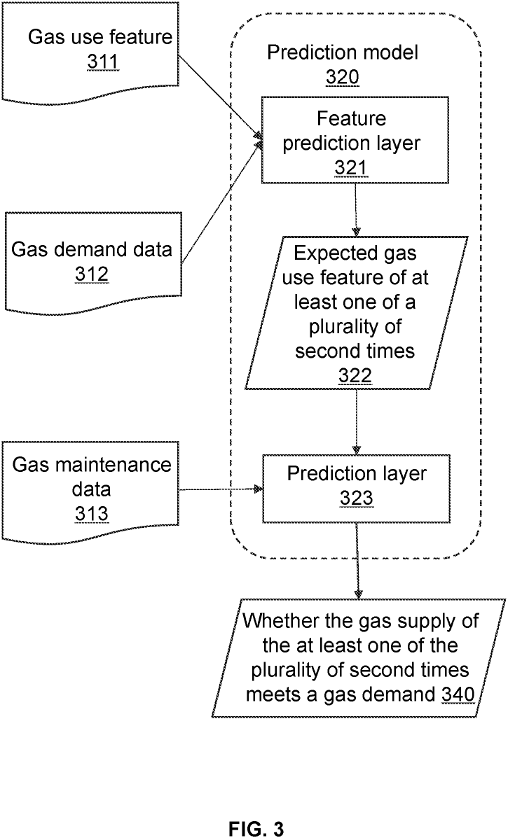

In some embodiments, the smart operation management sub-platform may determine the expected gas use feature of the at least one of the plurality of second times based on a prediction model and determine whether the gas supply of the at least one of the plurality of second times meets the gas demand. More descriptions about the prediction model may be found in FIG. 3 and the related descriptions.

In 240, in response to a prediction that the gas supply of the at least one of the plurality of the second times is incapable of meeting the gas demand, adjusting a gas dispatching plan.

The gas dispatching plan refers to a plan for dispatching the gas supply of the plurality of gas pipelines. In some embodiments, the gas dispatching plan at least includes a gas storage plan and a gas transmission plan.

The gas storage plan refers to a relevant plan for storing gas. In some embodiments, the gas storage plan includes at least one of a gas storage time, a gas storage volume, or a gas storage area. The gas storage area refers to an area where the backup gas storage device or backup gas pipeline is located.

The gas transmission plan refers to a relevant plan for the gas transmission of each gas pipeline. In some embodiments, the gas transmission plan may supply gas to a gas pipeline whose gas supply is incapable of meeting the gas demand by calling the gas. In some embodiments, the gas transmission plan may include a supply priority of each gas pipeline (the gas supply is given priority when the supply priority is higher, and the supply priority may be determined by manually preset), a supply source of each gas pipeline, a supply volume of each gas pipeline (the supply volume is smaller than or equal to the gas demand volume of the gas pipeline), etc. The supply source includes a gas supply based on a current pipeline, a gas supply based on the backup gas storage device or backup gas pipeline, etc. For example, the gas transmission plan of the gas pipeline A may include a relatively high supply priority, the supply source being the backup gas storage device, and the supply volume being smaller than the corresponding gas demand volume, etc. In some embodiments, the smart operation management sub-platform may determine the gas dispatching plan based on the expected gas use feature and whether the gas supply of the at least one of the plurality of second times meets the gas demand.

In some embodiments, when the gas supply of a certain gas pipeline is incapable of meeting the gas demand at a certain second time, the smart operation management sub-platform may determine the gas dispatching plan according to the expected gas use feature of the gas pipeline. For example, the gas may be stored in advance in the backup gas storage device or the backup gas pipeline in the gas storage area where the gas pipeline is located. The gas storage time may be set before the second time. The gas storage volume may be determined according to a difference between the gas supply volume and the gas demand volume. The gas demand volume may be determined according to the expected gas use feature.

In some embodiments, when the gas supplies of the plurality of gas pipelines at a certain second time are capable of meeting the gas demand, the gas storage area may be determined according to a second important coefficient of each gas pipeline. For example, the area where the gas pipeline whose second important coefficient exceeds a second threshold is determined as the gas storage area. The second important coefficient refers to an index to measure the supply priorities of different gas pipelines. For example, the higher the second important coefficient is, the higher the supply priority of the corresponding gas pipeline is. The second threshold refers to a threshold condition related to the second important coefficient. The second threshold may be a system default value, an experience value, a manually preset value, or any combination thereof, which may be set according to actual needs and not limited in the present disclosure.

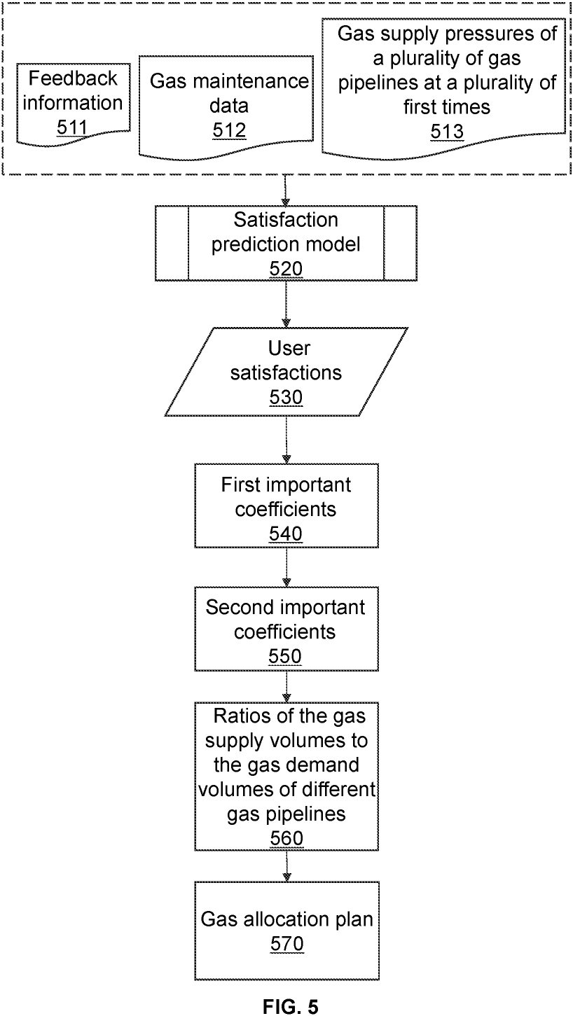

In some embodiments, when the gas supplies of the plurality of gas pipelines at a certain second time are incapable of meeting the gas demand, the supply priorities of the plurality of gas pipelines may be determined based on the second important coefficient of each gas pipeline. For example, the higher the second important coefficient is, the higher the supply priority is. For more description on the second important coefficient, please refer to FIG. 5 and related descriptions.

In some embodiments, when the gas supply of a certain gas pipeline at a certain second time is incapable of meeting the gas demand, the gas transmission plan in the gas dispatching plan may be adjusted. For example, the supply source of the gas pipeline may be adjusted from “gas supply based on the current pipeline” to “gas supply based on the backup gas storage device or the backup gas pipeline.”

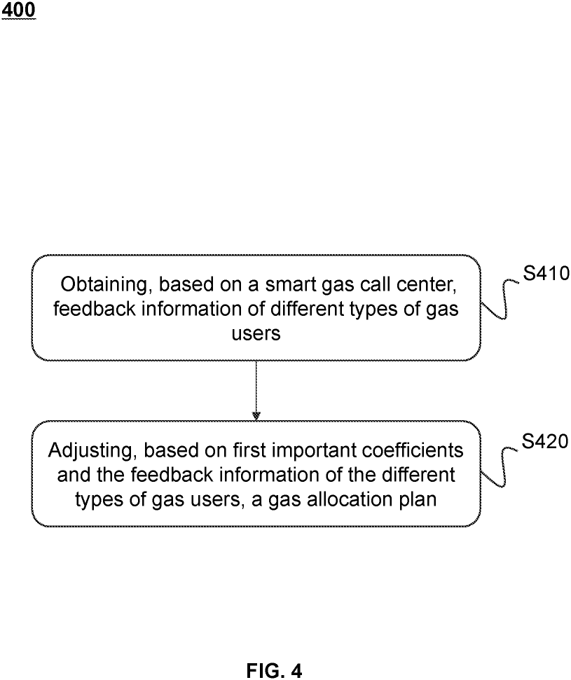

In some embodiments, the smart operation management sub-platform may obtain, based on the smart gas call center, feedback information of the different types of gas users; and adjust, based on first important coefficients of the different types of gas users and the feedback information, the gas dispatching plan. For more descriptions on adjusting the gas dispatching plan, please refer to FIG. 4 and its related descriptions.

In some embodiments of the present disclosure, the gas resource is dispatched according to the gas demands of different types of gas users, which can better meet the user’s gas use demand and improve the user’s gas use experience. At the same time, combined with relevant information such as the maintenance data of the smart gas call center, the impact of an emergency such as the gas device maintenance, etc. on the gas supply can be reduced, the gas supply and demand can be ensured as much as possible, and the impact of insufficient gas supply on the gas user can be reduced, thereby improving user satisfactions, saving costs, and improving gas supply efficiency.

It should be noted that the above description about the process 200 is only for the purpose of illustration, and does not limit the scope of application of the present disclosure. For those skilled in the art, various modifications and changes can be made to the process 200 under the guidance of the present disclosure. However, such modifications and changes are still within the scope of the present disclosure.

FIG. 3 is a schematic diagram illustrating an exemplary prediction model according to some embodiments of the present disclosure.

In some embodiments, the smart operation management sub-platform may determine an expected gas use feature 322 of at least one of a plurality of second times based on a prediction model 320 and further determine whether the gas supply of the at least one of the plurality of second times meets a gas demand 340.

The prediction model may be a machine learning model. For example, the prediction model may be a neural network (NN) model, a deep neural network (DNN) model, a recurrent neural network (RNN) model, or the like, or any combination thereof.

In some embodiments, an input of the prediction model 320 may be a gas use feature 311, gas demand data 312, and gas maintenance data 313, and an output of the prediction model 320 may be whether the gas supply of the at least one of the plurality of second times meets the gas demand 340. In some embodiments, the output of the prediction model may be represented by 0 or 1, 1 indicates that the gas supply meets the gas demand, and 0 indicates that the gas supply does not meet the gas demand. For more descriptions of the gas use feature, the gas demand data, and the gas maintenance data, please refer to FIG. 2 and the related descriptions.

In some embodiments, the prediction model 320 may include a feature determination layer 321 and a prediction layer 323.

In some embodiments, an input of the feature determination layer 321 may include the gas use feature 311 and the gas demand data 312, and an output of the feature determination layer 321 may include the expected gas use feature 322 of the at least one of the plurality of second times. For example, the input of the feature determination layer may be the gas use features and the gas demand data of one or more gas pipelines corresponding to 80,000 residential users, and the gas use features and the gas demand data of one or more gas pipelines corresponding to 50 industrial users, and the output of the feature determination layer may be the expected gas use features of one or more gas pipelines corresponding to the residential users and the expected gas use features of one or more gas pipelines corresponding to the industrial users at the plurality of second times. More descriptions about the expected gas use features may be found in FIG. 2 and the related descriptions.

In some embodiments, an input of the prediction layer 323 may include the expected gas use feature 322 of the at least one of the plurality of second times and the gas maintenance data 313, and an output of the prediction layer 323 may include whether the gas supply of the at least one of the plurality of second times meet the gas demand 340. For example, the output of the prediction layer may be {([c₁¹, 0], [c₂¹, 1], ...), ([c₁², 1], [c₂², 1], ...)}, indicating that the gas supply of a gas pipeline 1 at a second time c₁ does not meet the gas demand, the gas supply of the gas pipeline 1 at a second time c₂ meets the gas demand, etc., the gas supply of a gas pipeline 2 at the second time c₁ meets the gas demand, the gas supply of the gas pipeline 2 at the second time c₂ meets the gas demand, etc.

In some embodiments, the prediction model 320 may be obtained through joint training of the feature determination layer 321 and the prediction layer 323 based on a large number of first training samples with a first label.

In some embodiments, the first training samples may include sample gas use features, sample gas demand data, and sample gas maintenance data of a plurality of sample gas pipelines at a sample second time. The first label may include whether the gas supply of each sample gas pipeline at a sample second time meets the gas demand. In some embodiments, the first training samples may be obtained based on historical gas supply data. The first label may be determined by manual labeling.

An exemplary joint training process may include: inputting the sample gas use feature and the sample gas demand data into an initial feature determination layer and obtaining the expected gas use feature of at least one of a plurality of sample second times output by the initial feature determination layer; taking the output of the initial feature determination layer as training sample data, inputting the training sample data into an initial prediction layer together with sample maintenance data, and obtaining a result of whether the gas supply of the at least one of the plurality of second times output by the initial prediction layer meets the gas demand; and constructing a loss function based on the first label and the output of the initial prediction layer and updating synchronously parameters of the initial feature determination layer and the initial prediction layer. When the loss function meets a preset condition, the model training is completed, and a trained prediction model is obtained. The preset condition may be that the loss function converges, the count of iterations reaches a threshold of the count of iterations, etc.

In some embodiments, by predicting whether the gas supply meets the gas demand through the machine learning model, a more accurate result may be obtained compared with human judgment, thereby saving costs and resources. At the same time, by jointly training the plurality of processing layers of the prediction model, the accuracy of the prediction result of the prediction model can be effectively improved.

FIG. 4 is a flowchart illustrating an exemplary process for adjusting a gas dispatching plan according to some embodiments of the present disclosure.

In 410, obtaining, based on the smart gas call center, feedback information of the different types of gas users.

The feedback information refers to relevant information about a gas use that the gas user feeds back to the smart gas call center during the use of gas. For example, the feedback information may include gas user experience information on gas use, gas user complaint information and consulting information, and adjustment to gas demand data, etc.

In some embodiments, the feedback information may be obtained in various ways. For example, the smart gas call center may obtain the user feedback information by means of a questionnaire, etc. As another example, the smart gas call center may obtain the user feedback information through relevant information such as a user consultation, a user complaint, etc.

In 420, adjusting, based on first important coefficients and the feedback information of the different types of gas users, the gas dispatching plan.

The first important coefficient is a coefficient for evaluating an importance of the gas user. The first important coefficients of the different types of gas users may be the same or different. The first important coefficient may be represented by a numerical value of 1-10. The greater the numerical value is, the higher the importance of the user is.

In some embodiments, the first important coefficient may be set in advance based on the user’s gas use volume, a user type, etc. For example, the first important coefficients of a residential user, an industrial user, and a commercial user decrease in order. As another example, for the same type of gas users, the first important coefficient is positively correlated to the gas use volume. The greater the gas use volume is, the higher the first important coefficient is, etc.

As mentioned above, after the gas dispatching plan is determined based on the expected gas use feature and whether the gas supply of the at least one of the plurality of second times meets the gas demand, the gas dispatching plan may be further adjusted.

In some embodiments, the adjusting the gas dispatching plan based on first important coefficients and the feedback information of the different types of gas users includes: determining a supply priority of each gas pipeline based on the first important coefficient; and adjusting, based on the feedback information and the supply priority of each gas pipeline, a supply volume of each gas pipeline.

In some embodiments, for a certain gas pipeline, the supply priority of the gas pipeline may be determined according to a proportion of the first important coefficients of the plurality of gas users corresponding to the gas pipeline exceeding a first threshold. For example, the system may preset a proportion range of the first important coefficient exceeding the first threshold and the corresponding supply priority, and by determining a proportion range where an actual proportion locates, the supply priority of the gas pipeline may be determined. The proportion may be determined according to a count of gas users corresponding to the gas pipeline whose first important coefficients exceed the first threshold to a total count of users corresponding to the gas pipeline.

In some embodiments, for a certain gas pipeline whose priority is higher than a priority threshold, the supply volume of the gas pipeline may be adjusted based on the feedback information from the gas users whose first important coefficients meet the first threshold. For example, when the feedback information is that the gas supply is insufficient, the supply volume of the gas pipeline may be adjusted to be greater than the gas demand volume of the gas pipeline. The first threshold and the priority threshold may be system default values, experience values, manually preset values, or the like, or any combination thereof, which may be set according to actual needs and is not limited in the present disclosure.

In some embodiments, the smart operation management sub-platform may further predict user satisfactions based on the feedback information; adjust the first important coefficients based on the user satisfactions; determine, based on the adjusted first important coefficients, second important coefficients of different gas pipelines; and determine, based on the second important coefficients, ratios of the gas supply volumes to gas demand volumes of the different gas pipelines and adjust the gas dispatching plan. For more descriptions on adjusting the gas dispatching plan, please refer to FIG. 5 and its related descriptions.

In some embodiments of the present disclosure, the feedback information of the different types of users may be obtained based on the smart gas call center, and the gas dispatching plan may be further adjusted, which can better meet the gas use demand of the user, improve the user satisfactions, and effectively reduce user complaints.

FIG. 5 is an exemplary schematic diagram illustrating adjusting a gas dispatching plan according to some embodiments of the present disclosure.

In some embodiments, the adjusting the gas dispatching plan includes: predicting user satisfactions based on feedback information; adjusting the first important coefficients based on the user satisfactions; determining, based on the adjusted first important coefficients, second important coefficients of different gas pipelines; and determining, based on the second important coefficients, ratios of the gas supply volumes to gas demand volumes of the different gas pipelines and adjusting the gas dispatching plan.

The user satisfaction refers to an index for measuring the user’s satisfaction degree on a current gas supply condition. For example, the satisfaction may be represented by numbers 1-10. The greater the value is, the higher the user satisfaction is.

In some embodiments, the smart operation management sub-platform may process the feedback information to determine the user satisfaction. For example, the smart operation management sub-platform may determine the user satisfaction by comparing the feedback information with a second preset table. The second preset table includes various reference feedback information and reference user satisfactions corresponding to the various reference feedback information. In the comparison, actual feedback information is matched with the reference feedback information, and the reference user satisfaction corresponding to the reference feedback information meeting a preset condition (e.g., the same or the closest, etc.) is taken as a final user satisfaction.

In some embodiments, the smart operation management sub-platform may determine the user satisfactions 530 corresponding to a plurality of gas pipelines by processing the feedback information 511, the gas maintenance data 512, and gas supply pressures 513 of a plurality of gas pipelines at a plurality of first times based on a satisfaction prediction model 520.

The satisfaction prediction model may be a machine learning model. For example, the satisfaction prediction model may include various feasible models such as a RNN model, a DNN model, a convolutional neural network (CNN) model, or the like, or combination thereof.

In some embodiments, an input of the satisfaction prediction model 520 may be the feedback information 511 of all gas users of the plurality of gas pipelines, the gas maintenance data 512 of the plurality of gas pipelines, and the gas supply pressures 513 of the plurality of gas pipelines at the plurality of first times, and an output of the satisfaction prediction model 520 may be the user satisfactions 530 corresponding to the plurality of gas pipelines. A certain gas pipeline may be used to supply gas to one or more gas users of a same type. Accordingly, the user satisfaction corresponding to the certain gas pipeline may be an overall satisfaction of all gas users therein. For example, if the gas pipeline A corresponds to 3 residential users, the user satisfaction of the gas pipeline A may be the overall satisfaction of the 3 residential users.

In some embodiments, the plurality of user satisfactions output by the model may further be marked with labels. The labels are relevant to the user types. For example, if the user type corresponding to the gas pipeline A is the residential user, then the user satisfaction of the gas pipeline A output by the model may be marked as “residential user.”

The gas supply pressures of the plurality of gas pipelines at the plurality of first times may be obtained by a barometer at the first time. In some embodiments, the satisfaction prediction model may determine whether the gas supply pressures of the plurality of gas pipelines at the plurality of first times are within a reasonable range. When the gas supply pressures are not within the reasonable range, the user satisfaction may be relatively low. The reasonable range may be set manually.

In some embodiments, the satisfaction prediction model may be obtained through training a great number of second training samples with a second label. For example, the second training samples are input into an initial satisfaction prediction model, a loss function is constructed through the second label and a result of the initial satisfaction prediction model, and a parameter of the initial satisfaction prediction model is iteratively updated based on the loss function. When the loss function of the initial satisfaction prediction model meets a preset condition for the end of training, the model training is completed, and a trained satisfaction prediction model is obtained. The preset condition for the end of training may be that the loss function converges, the count of iterations reaches a threshold, etc.

In some embodiments, the second training samples may be sample feedback information of gas users corresponding to a plurality of sample gas pipelines, sample gas maintenance data of the plurality of sample gas pipelines, and sample gas supply pressures of the plurality of sample gas pipelines at the plurality of first times. The second label may be user satisfactions corresponding to the plurality of sample gas pipelines. In some embodiments, the second training samples may be determined based on historical data. For example, the training samples may be determined using historical feedback information, historical gas maintenance data, and historical gas supply pressures of the plurality of gas pipelines in the historical data. The second label may be determined by manual labeling.

In some embodiments, the user satisfaction may further be adjusted according to a count of complaints of the gas users. For example, for a certain gas pipeline, when the count of complaints of one or more gas users increases, the user satisfaction may be lowered accordingly.

In some embodiments, the smart operation management sub-platform may adjust first important coefficients 540 corresponding to one or more gas users of a certain gas pipeline according to the user satisfaction 530 corresponding to the gas pipeline. For example, the first important coefficients of the one or more gas users corresponding to the gas pipeline whose user satisfaction is higher than a satisfaction threshold may be lowered.

In some embodiments, the smart operation management sub-platform may determine second important coefficients 550 of different gas pipelines according to the adjusted first important coefficients. For example, the first important coefficients of the plurality of gas users corresponding to a certain gas pipeline may be weighted to determine the second important coefficient of the gas pipeline. The weight may be determined based on the user satisfaction of the gas user. For example, the higher the user satisfaction of a gas user, the lower the weight of the gas user.

In some embodiments, the smart operation management sub-platform may determine ratios 560 of the gas supply volumes to the gas demand volumes of different gas pipelines based on second important coefficients 550 and adjust the gas dispatching plan 570.

In some embodiments, the smart operation management sub-platform may determine the ratios of gas supply volumes to the gas demand volumes of the different gas pipelines based on the second important coefficients according to a preset rule. The preset rule may be that a priority is given to ensuring the gas supply of the gas pipeline with a relatively high second important coefficient. For example, assuming that the second important coefficient of the gas pipeline A is 1, it may be determined that the ratio of the gas supply volume to the gas demand volume of the gas pipeline A is 1:1; assuming that the second important coefficient of the gas pipeline B is 0.8, it may be determined that the ratio of the gas supply volume to the gas demand volume of the gas pipeline B is 0.8:1.

In some embodiments, the smart operation management sub-platform may adjust an initial gas dispatching plan according to the ratios of the gas supply volumes to the gas demand volumes.

In some embodiments of the present disclosure, the gas dispatching plan may be adjusted based on the user feedback and the user satisfactions, so that the gas dispatching can be more in line with user needs.

One or more embodiments of the present disclosure also provide a non-transitory computer readable storage medium storing computer instructions. When the computer instructions are executed by a processor, the method for gas resource dispatching based on a smart gas call center according to any of the above embodiments may be executed by the computer.

The basic concepts have been described above, apparently, for those skilled in the art, the above-mentioned detailed disclosure is only used as an example, and it does not constitute a limitation of the present disclosure. Although not expressly stated here, those skilled in the art may make various modifications, improvements, and corrections to this description. Such modifications, improvements, and corrections are suggested in the present disclosure, so such modifications, improvements, and corrections still belong to the spirit and scope of the embodiments of the present disclosure.

At the same time, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that two or more references of “an embodiment” or “one embodiment” or “an alternative embodiment” in various places in the present disclosure do not necessarily refer to the same embodiment. In addition, some features, structures, or features in the present disclosure of one or more embodiments may be appropriately combined.

In addition, unless explicitly stated in the claims, the order of processing elements and sequences described in the present disclosure, the use of numbers and letters, or the use of other names are not configured to limit the sequence of processes and methods in the present disclosure. Although the above disclosure discusses through various examples what is currently considered to be a variety of useful embodiments of the disclosure, it is to be understood that such detail is solely for that purpose of description and that the appended claims are not limited to the disclosed embodiments, on the contrary, are intended to cover modifications and equivalent combinations that are within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in the present disclosure and help the understanding of one or more embodiments of the invention, in the foregoing description of the embodiments of the present disclosure, sometimes multiple features are combined into one embodiment, drawings or descriptions thereof. However, this disclosure method does not mean that the characteristics required by the object of the present disclosure are more than the features mentioned in the claims. Rather, claimed subject matter may lie in less than all features of a single foregoing disclosed embodiment.

Some examples use numbers to describe quantities of ingredients and attributes, it should be understood that such numbers used to describe the examples, in some examples, use the modifiers “about”, “approximately” or “substantially” to retouch. Unless stated otherwise, “about”, “approximately” or “substantially” means that a variation of ±20% is allowed for the stated number. Accordingly, in some embodiments, the numerical parameters set forth in the present disclosure and the claims are approximations that can vary depending upon the desired features of individual embodiments. In some embodiments, the numerical parameters should consider the specified significant digits and use a general digit reservation method. Notwithstanding that the numerical fields and parameters used in some embodiments of this disclosure to confirm the breadth of their ranges are approximations, in specific embodiments such numerical values are set as precisely as practicable.

For each patent, patent application, patent application publication, and other material, such as an article, a book, a specification, a publication, a document, etc., cited in this disclosure, the entire contents are hereby incorporated into this disclosure for reference. Excepting any prosecution file history associated with same, any of same that is inconsistent with or in conflict with the present document, or any of same that may have a limiting effect as to the broadest scope of the claims now or later associated with the present document. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described herein are only used to illustrate the principles of the embodiments of the present disclosure. Other modifications are also possible within the scope of the present disclosure. Therefore, merely by way of example and not limitation, alternative configurations of the embodiments of the present disclosure may be considered consistent with the teachings of the present disclosure. Accordingly, the embodiments of the present specification are not limited to those embodiments expressly introduced and described in the present disclosure.

What is claimed is:

1. A method for gas resource dispatching based on a smart gas call center, wherein the method is executed by a smart gas management platform of an Internet of Things (IoT) system for gas resource dispatching based on a smart gas call center, and the method comprises:
obtaining gas use data of different types of gas users and determining a gas use feature, the gas use feature at least including the gas use data of the different types of gas users at a plurality of first times;
obtaining gas demand data, the gas demand data including a demand time and a demand volume;
predicting, based on the gas use feature, the gas demand data, and gas maintenance data of the smart gas call center, whether a gas supply of at least one of a plurality of second times meets a gas demand; and
in response to a prediction that the gas supply of the at least one of the plurality of the second times is incapale of meeting the gas demand, adjusting a gas dispatching plan.

2. The method of claim 1, wherein the IoT system for gas resource dispatching based on a smart gas call center includes a smart gas user platform, a smart gas service platform, a smart gas management platform, a smart gas sensor network platform, and a smart gas object platform that interact sequentially, and the smart gas management platform at least includes a smart operation management sub-platform and a smart gas data center;
the smart gas data center is configured to obtain the gas use data and the gas demand data and send the gas use data and the gas demand data to the smart operation management sub-platform for processing; and
the smart operation management sub-platform is configured to process the gas use data and the gas demand data, send gas dispatching management information to the smart gas data center, and send the gas dispatching management information to the smart gas user platform via the smart gas service platform.

3. The method of claim 1, wherein the predicting, based on the gas use feature, the gas demand data, and gas maintenance data of the smart gas call center, whether a gas supply of at least one of a plurality of second times meets the gas demand comprises:
predicting, based on the gas use feature and the gas demand data, an expected gas use feature of the at least one of the plurality of second times; and
predicting, based on the expected gas use feature of the at least one of the plurality of second times and the gas maintenance data, whether the gas supply of the at least one of the plurality of second times meets the gas demand.

4. The method of claim 3, wherein the predicting, based on the gas use feature, the gas demand feature, and the gas maintenance data of the smart gas call center, whether a gas supply of at least one of a plurality of second times meets a gas demand comprises:
determining the expected gas use featuer of the at least one of the plurality of second times based on a prediction model and determining whether the gas supply of the at least one of the plurality of second times meets the gas demand, wherein the prediction model is a machine learning model and includes a feature determination layer and a prediction layer;
an input of the feature determination layer includes the gas use feature and the gas demand data, and an output of the feature determination layer includes the expected gas use featue of the at least one of the plurality of second times; and
an input of the prediction layer includes the expected gas use feature of the at least one of the plurality of second times and the gas maintenance data, and an output of the prediction layer includes whether the gas supply of the at least one of the plurality of second times meets the gas demand.

5. The method of claim 3, further comprising:
determining, based on the expected gas use feature and the whether the gas supply of the at least one of the plurality of second times meets the gas demand, the gas dispatching plan, wherein the gas dispatching plan at least includes a gas storage plan and a gas transmission plan.

6. The method of claim 5, wherein the gas storage plan includes at least one of a gas storage time, a gas storage volume, or a gas storage area.

7. The method of claim 1, wherein the in response to a prediction that the gas supply of the at least one of the plurality of the second times is incapable of meeting the gas demand, adjusting a gas dispatching plan comprises:
obtaining, based on the smart gas call center, feedback information of the different types of gas users; and
adjusting, based on first important coefficients and the feedback information of the diffrent types of gas users, the gas dispatching plan.

8. The method of claim 7, wherein the adjusting the gas dispatching plan comprises:
predicting user satisfactions based on the feedback information;
adjusting the first important coefficients based on the user satisfactions;
determining, based on the adjusted first important coefficients, second important coefficients of different gas pipelines; and
determining, based on the second important coefficients, ratios of gas supply volumes to gas demand volumes of the different gas pipelines and adjusting the gas dispatching plan.

9. The method of claim 8, wherein the predicting user satisfactions based on the feedback information comprises:
determining the user satisfactions corresponding to a plurality of gas pipelines by processing the feedback information, the gas maintenance data, and gas supply pressures of the plurality of gas pipelines at the plurality of first times based on a satisfaction prediction model, wherein the satisfaction prediction model is a machine learning model.

10. An Internet of Things (loT) system for gas resource dispatching based on a smart gas call center, wherein the loT system includes a smart gas user platform, a smart gas service platform, a smart gas management platform, a smart gas sensor network platform, and a smart gas object platform that interact sequentially, and the smart gas management platform at least includes a smart operation management sub-platform and a smart gas data center;
the smart gas data center is configured to obtain gas use data and gas demand data of different types of gas users and send the gas use data and the gas demand data to the smart operation management sub-platform for processing, the gas demand data including a demand time and a demand volume; and
the smart operation management sub-platform is configured to:
determine a gas use feature based on the gas use data, the gas use feature at least including the gas use data of the different types of gas users at a plurality of first times;
predict, based on the gas use feature, the gas demand data, and gas maintenance data of the smart gas call center, whether a gas supply of at least one of a plurality of second times meet a gas demand;
in response to a prediction that the gas supply of the at least one of the plurality of the second times is incapale of meeting the gas demand, adjust a gas dispatching plan; and
send the adjusted gas dispatching plan to the smart gas data center and send the adjusted gas dispatching plan to the smart gas user platform via the smart gas service platform.

11. The IoT system of claim 10, wherein to predict, based on the gas use feature, the gas demand data, and gas maintenance data of the smart gas call center, whether a gas supply of at least one of a plurality of second times meets a gas demand, the smart operation management sub-platform is configured to:
predict, based on the gas use feature and the gas demand data, an expected gas use feature of the at least one of the plurality of second times; and
predict, based on the expected gas use feature of the at least one of the plurality of second times and the gas maintenance data, whether the gas supply of the at least one of the plurality of second times meets the gas demand.

12. The IoT system of claim 11, wherein to predict, based on the gas use feature, the gas demand data, and gas maintenance data of the smart gas call center, whether a gas supply of at least one of a plurality of second times meets a gas demand, the smart operation management sub-platform is further configured to:
determine the expected gas use feature of the at least one of the plurality of second times based on a prediction model and determine whether the gas supply of the at least one of the plurality of second times meets the gas demand, wherein the prediction model is a machine learning model and includes a feature determination layer and a prediction layer;
an input of the feature determination layer includes the gas use feature and the gas demand data, and an output of the feature determination layer includes the expected gas use featue of the at least one of the plurality of second times; and
an input of the prediction layer includes the expected gas use feature of the at least one of the plurality of second times and the gas maintenance data, and an output of the prediction layer includes whether the gas supply of the at least one of the plurality of second times meets the gas demand.

13. The loT system of claim 11, wherein the smart operation management sub-platform is configured to:
determine, based on the expected gas use feature and the whether the gas supply of the at least one of the plurality of second times meets the gas demand, the gas dispatching plan, wherein the gas dispatching plan at least includes a gas storage plan and a gas transmission plan.

14. The IoT system of claim 13, wherein the gas storage plan includes at least one of a gas storage time, a gas storage volume, or a gas storage area.

15. The IoT system of claim 10, wherein to adjust, in response to a prediction that the gas supply of the at least one of the plurality of the second times is incapable of meeting the gas demand, the gas dispatching plan, the smart operation management sub-platform is configured to:
obtain, based on the smart gas call center, feedback information of the different types of gas users; and
adjust, based on first important coefficients and the feedback information of the different types of gas users, the gas dispatching plan.

16. The IoT system of claim 15, wherein to adjust the gas dispatching plan, the smart operation management sub-platform is configured to:
predict user satisfactions based on the feedback information;
adjust the first important coefficients based on the user satisfactions;
determine, based on the adjusted first important coefficients, second important coefficients of different gas pipelines; and
determine, based on the second important coefficients, ratios of gas supply volumes to gas demand volumes of the different gas pipelines and adjust the gas dispatching plan.

17. The IoT system of claim 16, wherein the smart gas management platform further includes a smart customer service management sub-platform, and to predict the user satisfactions based on the feedback information, the smart customer service management sub-platform is configured to:
determinine the user satisfactions corresponding to a plurality of gas pipelines by processing the feedback information, the gas maintenance data, and gas supply pressures of the plurality of gas pipelines at the plurality of first times based on a satisfaction prediction model, wherein the satisfaction prediction model is a machine learning model.

18. A non-transitory computer readable storage medium storing computer instructions, wherein when the computer instructions are executed by a processor, the method for gas resource dispatching based on a smart gas call center according to claim 1 is implemented.
